(19) United States
(12) Patent Application Publication
(10) Pub. No.: US 2015/0194177 A1
(43) Pub. Date: Jul. 9, 2015

(54) OPTICAL INFORMATION RECORDING DEVICE AND OPTICAL INFORMATION RECORDING METHOD

(71) Applicant: Hitachi-LG Data Storage, Inc., Tokyo (JP)

(72) Inventors: Naohito IKEDA, Tokyo (JP); Kouichirou NISHIMURA, Tokyo (JP)

(21) Appl. No.: 14/591,806

(22) Filed: Jan. 7, 2015

(30) Foreign Application Priority Data
Jan. 8, 2014 (JP) 2014-001337

(51) Int. Cl. G11B 7/0065

(52) U.S. Cl. CPC G11B 7/0065; G11B 2007/00653

(57) ABSTRACT

An optical information recording device for recording digital information in an optical information recording medium by use of holography, the device including a light source for outputting an optical beam for recording information in the optical information recording medium, and a recording processing control unit for inputting the optical beam output from the light source at an incident angle different from an incident angle of an optical beam on the optical information recording medium when the digital information is reproduced from the optical information recording medium thereby to perform a pre-processing or post-processing, and an optical information recording method used for the optical information recording device.

### CROSS-REFERENCE TO RELATED APPLICATIONS

This application claims the priority of Japanese Patent Application No. 2014-001337, filed on Jan. 8, 2014, which is incorporated herein by reference in its entirety.

### BACKGROUND OF THE INVENTION

1. Field of the Invention

The present invention relates to an optical information recording device and optical information recording method for recording information in an optical information recording medium by use of holography.

2. Description of the Related Art

At present, optical disks with a recording capacity of about 50 GB can be commercialized for general consumers in the Blue-ray Disc™ standard using a blue-violet semiconductor laser. It is desired in the future that the optical disk is increased in its capacity up to as much as a HDD (Hard Disk Drive) capacity of 100 GB to 1 TB.

However, a high density technique in a new system different from a high density technique with shorter wavelength and higher NA objective lens is required for realizing an optical disk with such an extra-high density.

While a search on a next-generation storage technique is being made, a hologram recording technique for recording digital information by use of holography is being paid attention.

The hologram recording technique is directed for recording information in a recording medium by overlaying a signal light having information on page data two-dimensionally modulated by a spatial optical modulator with a reference light inside the recording medium and generating refractive index modulation in the recording medium due to an interference pattern occurring at this time.

When the reference light used for recording is irradiated on the recording medium while the information is reproduced, a hologram recorded in the recording medium operates as a diffractive grating thereby to generate a diffractive light. The diffractive light is reproduced as the same light as the recorded signal light including phase information.

The reproduced signal light is two-dimensionally and rapidly detected by use of an optical detector such as CMOS or CCD. In this way, the hologram recording technique can correctively record 2D information in an optical recording medium by one hologram and reproduce the information, and can overwrite a plurality of items of page data at a certain location in the recording medium, thereby recording and reproducing large-capacity and high-speed information.

The hologram recording technique is described in JP 2004-272268 A, for example. The Publication discloses therein a multiplexing method and device by which a hologram is spatially multiplexed due to partially spatial superimposition of holograms between adjacent stacks.

An optical information recording/reproducing device for recording digital information by use of holography requires an optical system for generating and irradiating cure optical beams for pre-cure and post-cure on a recording medium in addition to an optical system for generating and irradiating a signal light and a reference light on the recording medium. The pre-cure is a pre-step of previously irradiating a predetermined optical beam on recording a hologram, and the post-cure is a post-step of recording information at a desired position, and then irradiating an optical beam for disabling the desired position to be additionally recorded. The optical beam specialized for cure is typically used for pre-cure and post-cure, but JP 2009-076171 A discloses therein an example in which a reference light beam is used instead of a cure beam in order to downsize the device.

### SUMMARY OF THE INVENTION

A new problem has been caused through an experiment by the inventors when the reference light beam described in Patent Literature 2 is used instead of a cure beam. The problem will be described below. The reference light beam is a high-interference beam for recording an interference pattern generated when interfering with a signal light as a hologram. There is observed a phenomenon that when the reference light beam is irradiated on a recording medium on pre-cure, the reference light beams reflects on the backside of the recording medium. It is revealed that when the phenomenon occurs, an incident light into the recording medium interferes with the reflected light from the backside of the recording medium, and an unwanted hologram, which should not be generated, is generated. The unwanted hologram generated on pre-cure is a large noise source for reproducing the hologram recording information therein after the cure processing, and there is a problem that reproduction quality is deteriorated due to the fact. A method for solving the problem is not disclosed, and the problem is not solved.

It is an object of the present invention to provide an optical information recording device and an optical information recording method suitable for solving the problem caused when a high-interference beam is applied to a cure processing.

The problem is solved by the invention described in Claims, for example.

According to the present invention, it is possible to provide a suitable optical information recording device and optical information recording method.

### BRIEF DESCRIPTION OF THE DRAWINGS

FIG. 1 is a schematic diagram of a method for performing a cure processing with a high-interference beam;

FIG. 2 is a schematic diagram illustrating an embodiment of an optical information recording/reproducing device;

FIG. 3 is a schematic diagram illustrating an embodiment of a pickup inside the optical information recording/reproducing device;

FIG. 4 is a schematic diagram illustrating the embodiment of the pickup inside the optical information recording/reproducing device;

FIG. 5 is a schematic diagram of a problem when a high-interference beam is irradiated on an optical information recording medium;

FIG. 6A is a flowchart illustrating the operations until recording or reproducing is completely prepared after an optical information recording medium is inserted into the optical information recording/reproducing device;

FIG. 6B is a flowchart illustrating the operations until information is recorded in the optical information recording medium 1 from the preparation completed state after the optical information recording medium is inserted into the optical information recording/reproducing device;

FIG. 6C is a flowchart illustrating the operations until the information recorded in the optical information recording medium 1 is reproduced from the preparation completed state after the optical information recording medium is inserted into the optical information recording/reproducing device;

FIG. 7A is a schematic diagram illustrating angle selectivity of a hologram;

FIG. 7B is a schematic diagram illustrating angle selectivity of a hologram;

FIG. 8 is a schematic diagram illustrating a property of an optical information recording medium;

FIG. 9A is a schematic diagram illustrating angle selectivity of a hologram when a pre-cure beam with constant energy is irradiated at a predetermined angle;

FIG. 9B is a schematic diagram illustrating angle selectivity of a hologram when a pre-cure beam is divided and irradiated at a plurality of angles;

FIG. 10A is a schematic diagram illustrating how pre-cure is when a plurality of books are recorded;

FIG. 10B is a schematic diagram illustrating how pre-cure is when a plurality of books are recorded;

FIG. 11 is a flowchart illustrating an embodiment in which pre-cure is performed with a high-interference beam;

FIG. 12 is a flowchart illustrating an embodiment in which pre-cure is performed with a high-interference beam at a plurality of angles;

FIG. 13 is a flowchart illustrating an embodiment in which pre-cure is performed with a high-interference beam at different wavelengths;

FIG. 14 is a flowchart illustrating an embodiment in which pre-cure is performed by applying a high frequency to a high-interference beam;

FIG. 15 is a flowchart illustrating an embodiment in which pre-cure with a reference light is applied to consecutive book recording; and

FIG. 16 is a flowchart illustrating an embodiment in which post-cure is performed with a high-interference beam.

### DESCRIPTION OF THE PREFERRED EMBODIMENTS

Embodiments according to the present invention will be described below with reference to the drawings.

### First Embodiment

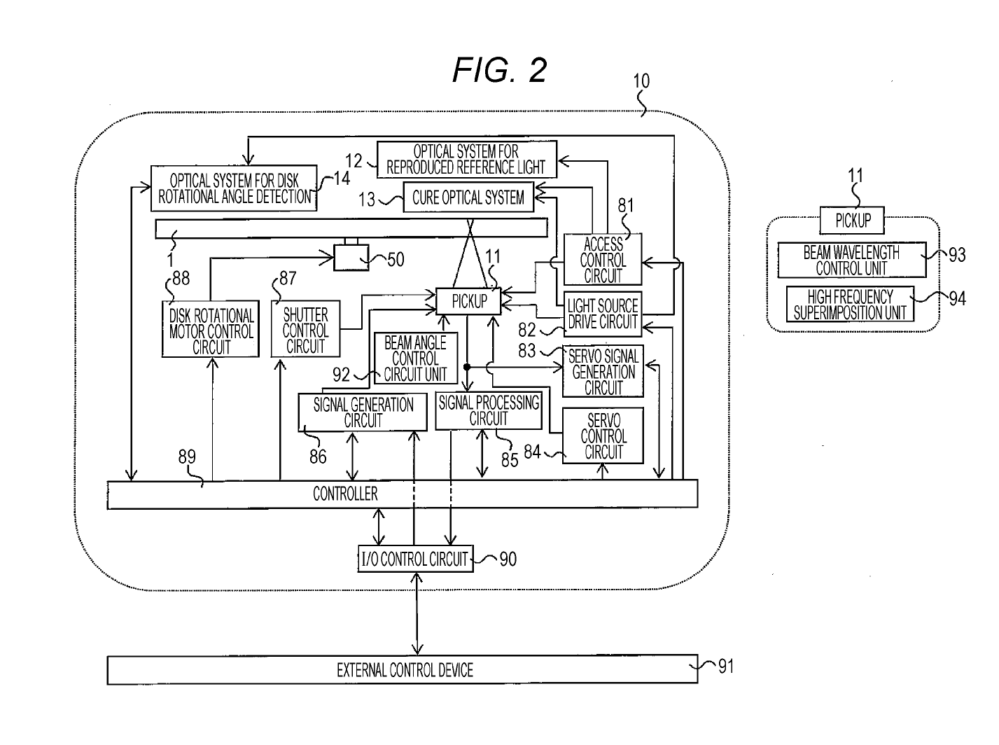

The embodiments according to the present invention will be described with reference to the accompanying drawings. FIG. 2 is a block diagram illustrating a recording/reproducing device for an optical information recording medium for recording and/or reproducing digital information by use of holography.

An optical information recording/reproducing device 10 is connected to an external control device 91 via an I/O control circuit 90. On recording, the optical information recording/reproducing device 10 receives an information signal to be recorded from the external control device 91 via the I/O control circuit 90.

The optical information recording/reproducing device 10 includes a pickup 11, an optical system 12 for reproduced reference light, a cure optical system 13, an optical system 14 for disk rotational angle detection, and a rotational motor 50, and an optical information recording medium 1 is configured to be rotatable by the rotational motor 50.

The pickup 11 serves to irradiate a reference light and a signal light on the optical information recording medium 1 and to record digital information in the recording medium by use of holography. At this time, an information signal to be recorded is sent to a spatial optical modulator inside the pickup 11 by a controller 89 via a signal generation circuit 86, and the signal light is modulated by the spatial optical modulator. A light source 301 included in the pickup 11 can control an irradiation angle to irradiate onto the optical information recording medium 1 by a beam angle control unit 92 for controlling an irradiation angle of a reference light or a cure beam. The pickup 11 includes a beam wavelength control unit 93 for controlling a wavelength of an optical beam, and a high frequency superimposition unit 94 for controlling superimposition of a high frequency component on an optical beam.

When the information recorded in the optical information recording medium 1 is reproduced, a light wave for inputting the reference light exiting from the pickup 11 into the optical information recording medium in the reverse direction to the recording is generated in the optical system 12 for reproduced reference light. A reproduced light reproduced by the reproduced reference light is detected by an optical detector described later inside the pickup 11, and the signal is reproduced by a signal processing circuit 85.

A time for irradiating a reference light and a signal light to be irradiated on the optical information recording medium 1 can be adjusted by controlling an open/close time of a shutter inside the pickup 11 by the controller 89 via a shutter control circuit 87.

The cure optical system 13 serves to generate an optical beam used for pre-cure and post-cure in the optical information recording medium 1. The pre-cure is a pre-step of previously irradiating a predetermined optical beam prior to irradiating a reference light and a signal light on desired positions in order to record information at a desired position in the optical information recording medium 1. The post-cure is a post-step of irradiating a predetermined optical beam for disabling a desired position to be additionally recorded after recording information at the desired position in the optical information recording medium 1.

The optical system 14 for disk rotational angle detection is used for detecting a rotational angle of the optical information recording medium 1. When the optical information recording medium 1 is adjusted at a predetermined rotational angle, a signal depending on a rotational angle is detected by the optical system 14 for disk rotational angle detection, and the rotational angle of the optical information recording medium 1 can be controlled by use of the detected signal by the controller 89 via a disk rotational motor control circuit 88.

Predetermined light source drive current is supplied from a light source drive circuit 82 to the light sources inside the pickup 11, the cure optical system 13, and the optical system 14 for disk rotational angle detection, and an optical beam with a predetermined amount of light can be emitted from each of the light sources.

The pickup 11 and the disk cure optical system 13 are provided with a mechanism capable of sliding their positions in the radius direction of the optical information recording medium 1, and can perform positional control via an access control circuit 81.

A recording technique using the principle of holography angle multiplexing tends to be remarkably smaller in its permitted error relative to an offset of a reference light angle.

Therefore, a mechanism for detecting the amount of offset of a reference light angle needs to be provided in the pickup 11 thereby to generate a signal for servo control in a servo signal generation circuit 83, and a servo mechanism for correcting the amount of offset via a servo control circuit 84 needs to be provided in the optical information recording/reproducing device 10.

Some or all of the pickup 11, the cure optical system 13 and the optical system 14 for disk rotational angle detection may be put into together to be simplified.

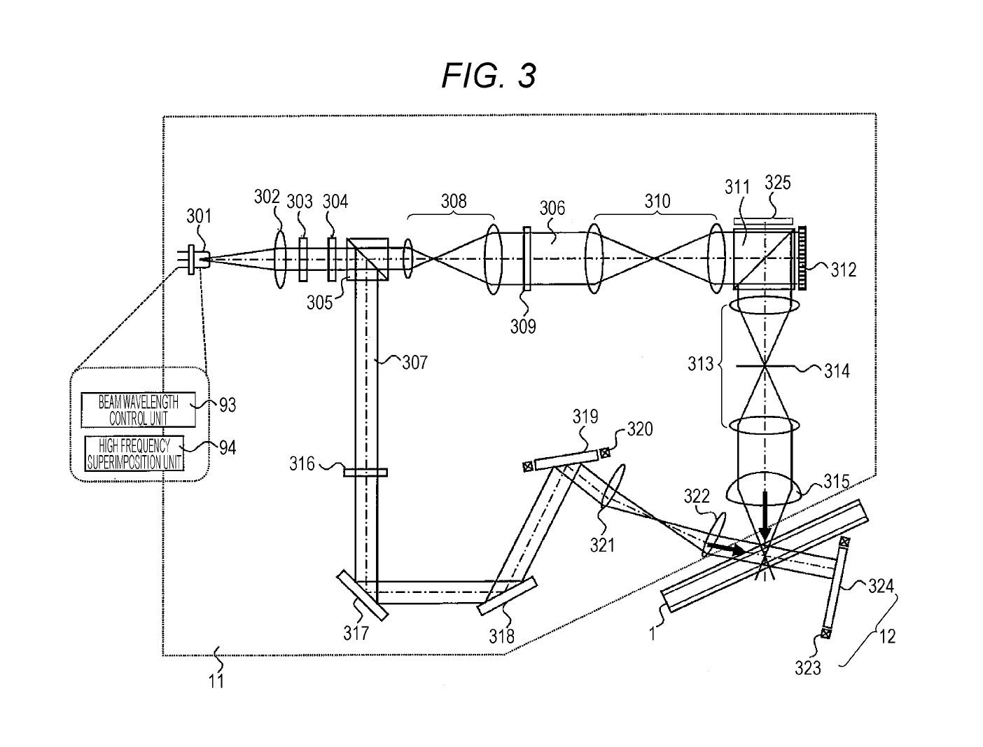

FIG. 3 illustrates a recording principle in an exemplary basic optical system structure of the pickup 11 in the optical information recording/reproducing device 10. An optical beam exiting from the light source 301 transmits through a collimate lens 302 and inputs into a shutter 303. When the shutter 303 is open, the optical beam passes through the shutter 303, and then is controlled in its deflection direction such that a ratio of the amounts of light of a p deflected light and an s deflected light is at a desired ratio by an optical device 304 configured of a ½ wavelength plate, for example, and then is input into a PBS (Polarization Beam Splitter) prism 305.

The optical beam transmitting through the PBS prism 305 works as a signal light 306 to be enlarged in its optical beam diameter by a beam expander 308, and then transmits through a phase mask 309, a relay lens 310, and a PBS prism 311 to be incident into a spatial optical modulator 312.

The signal light added with information by the spatial optical modulator 312 reflects on the PBS prism 311, and propagates through a relay lens 313 and a spatial filter 314. Thereafter, the signal light is collected in the optical information recording medium 1 by an objective lens 315.

On the other hand, the optical beam reflecting on the PBS prism 305 works as a reference light 307 and is set in a predetermined deflection direction depending on recording or reproducing by a light deflection direction conversion device 316, and then is incident into a galvanic mirror 319 via a mirror 317 and a mirror 318. The galvanic mirror 319 can adjust an angle by an actuator 320, and thus can set an incident angle of the reference light passing through a lens 321 and a lens 322 and then inputting into the optical information recording medium 1 at a desired angle. A galvanic mirror is used by way of example in the present example in order to set an incident angle of a reference light, but any device for changing an incident angle may be used instead of a galvanic mirror. Alternatively, a device for converting a wavefront of a reference light may be employed.

In this way, a signal light and a reference light are incident to be mutually superimposed in the optical information recording medium 1 so that an interference pattern is formed in the recording medium, and the pattern is written into the recording medium thereby to record information. An incident angle of the reference light to be incident into the optical information recording medium 1 can be changed by the galvanic mirror 319, and thus recording at multiplexed angles is enabled.

In the following, for the holograms recorded in the same area at different reference light angles, a hologram corresponding to each reference light angle will be called page, and a collection of pages angle-multiplexed in the same area will be called book.

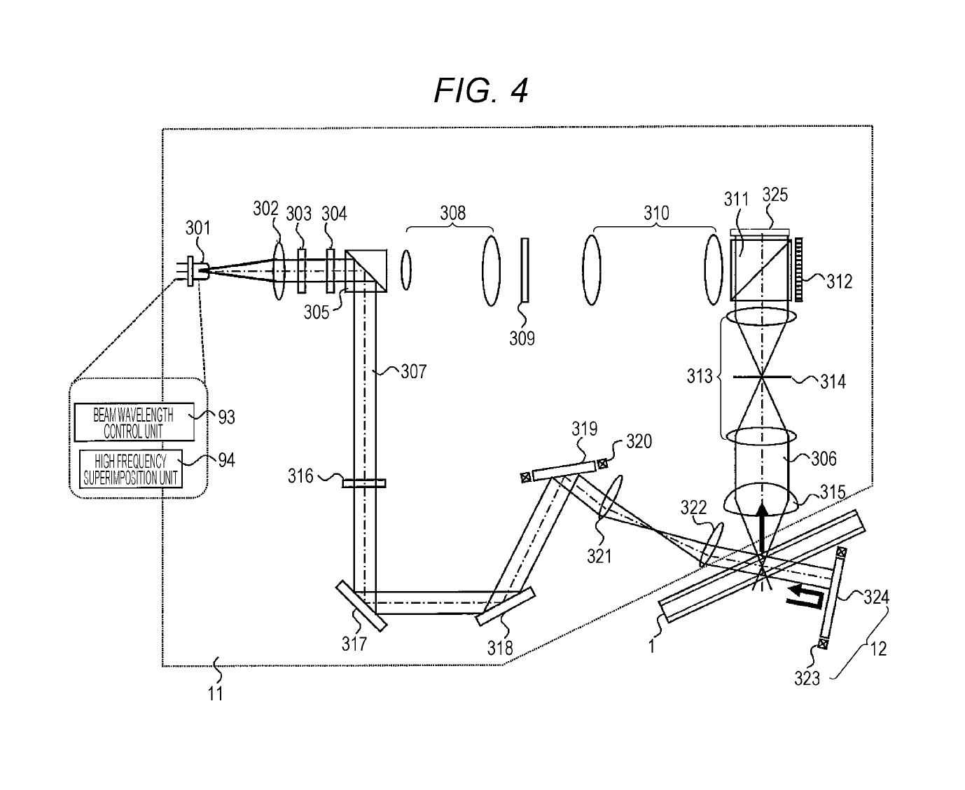

FIG. 4 illustrates a reproduction principle in an exemplary basic optical system structure of the pickup 11 in the optical information recording/reproducing device 10. When the recorded information is reproduced, as described above, a reference light is incident into the optical information recording medium 1 and an optical beam transmitting through the optical information recording medium 1 is reflected on an angle adjustable galvanic mirror 324 by an actuator 323, thereby generating a reproduced reference light thereof.

A reproduced light reproduced by the reproduced reference light propagates through the objective lens 315, the relay lens 313 and the spatial filter 314. Thereafter, the reproduced light transmits through the PBS prism 311 to be incident into an optical detector 325, thereby reproducing the recorded signal. A shooting device such as CMOS image sensor or CCD image sensor may be employed as the optical detector 325, but any device capable of reproducing page data may be employed.

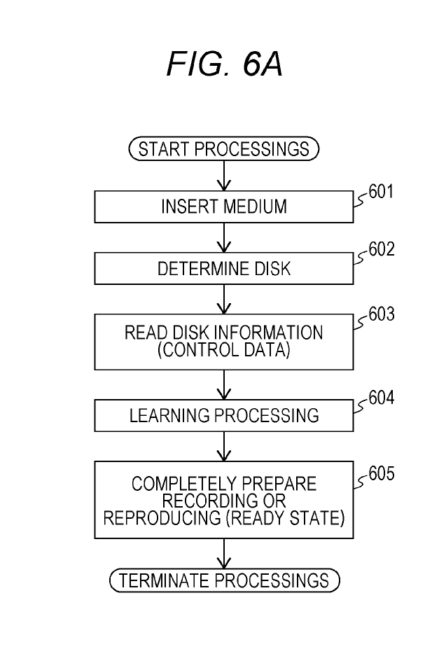

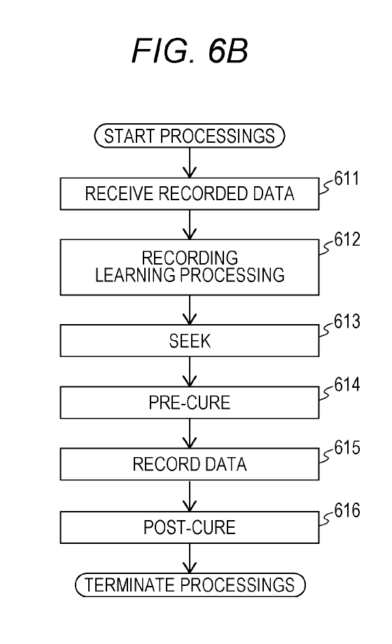

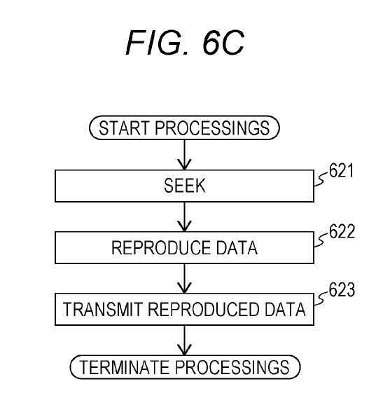

FIGS. 6A to 6C illustrate the recording and reproducing operation flows in the optical information recording/reproducing device 10. Herein, the recording/reproducing flows using holography will be particularly described.

FIG. 6A illustrates an operation flow until recording or reproducing is completely prepared after the optical information recording medium 1 is inserted into the optical information recording/reproducing device 10, FIG. 6B illustrates an operation flow until information is recorded into the optical information recording medium 1 from the preparation completed state, and FIG. 6C illustrates an operation flow until the information recorded in the optical information recording medium 1 is reproduced from the preparation completed state.

As illustrated in FIG. 6A, when being inserted with the medium (601), the optical information recording/reproducing device 10 makes a disk determination as to whether the inserted medium is a medium for recording or reproducing digital information by use of holography (602).

As a result of the disk determination, when determining that the medium is an optical information recording medium for recording or reproducing digital information by use of holography, the optical information recording/reproducing device 10 reads control data provided in the optical information recording medium (603), and acquires information on the optical information recording medium, or information on various setting conditions on recording or reproducing, for example.

After reading the control data, the optical information recording/reproducing device 10 performs a learning processing (604) for various adjustments or the pickup 11 depending on the control data, and completes the recording or reproducing preparation (605).

In the operation flow until information is recorded from the preparation completed state, as illustrated in FIG. 6B, data to be recorded is first received (611), and information depending on the data is sent to the spatial optical modulator 312 in the pickup 11.

Then, various learning processings for recording such as power optimization of the light source 301 or optimization of an exposure time by the shutter 303 are previously performed as needed in order to record high-quality information in the optical information recording medium (612).

Then, the access control circuit 81 is controlled in a seek operation (613) thereby to position the pickup 11 and the cure optical system 13 at predetermined positions in the optical information recording medium. When the optical information recording medium 1 has address information, the address information is reproduced thereby to confirm whether they are positioned at the target positions, and when they are not positioned at the target positions, the amounts of offset relative to the predetermined positions are calculated, respectively, and the positioning operation is repeated again.

Thereafter, an optical beam exiting from the cure optical system 13 is used to pre-cure a predetermined area (614), and a reference light and a signal light exiting from the pickup 11 are used to record data (615).

After the data is recorded, an optical beam exiting from the cure optical system 13 is used to perform post-cure (616). The data may be verified as needed. Herein, the pre-cure processing as a pre-processing of making the optical information recording medium into a reaction active state, and the post-cure processing as a post-processing of recording a hologram in the optical information recording medium, and then stabilizing the state of the medium and fixing the recorded information may be called cure processings.

In the operation flow until the recorded information is reproduced from the preparation completed state, as illustrated in FIG. 6C, the access control circuit 81 is first controlled in a seek operation (621) thereby to position the pickup 11 and the optical system 12 for reproduced reference light at predetermined positions in the optical information recording medium. When the optical information recording medium 1 has address information, the address information is reproduced to confirm whether they are at the target positions, and when they are not positioned at the target positions, the amounts of offset relative to the predetermined positions are calculated, respectively, and the positioning operation is repeated again.

Thereafter, the reference light exits from the pickup 11, the information recorded in the optical information recording medium is read (622), and reproduced data is transmitted (623).

A method for preventing deterioration in data reproduction quality also when the pre-cure processing is performed by use of a high-interference beam invented by the inventors will be described herein in detail.

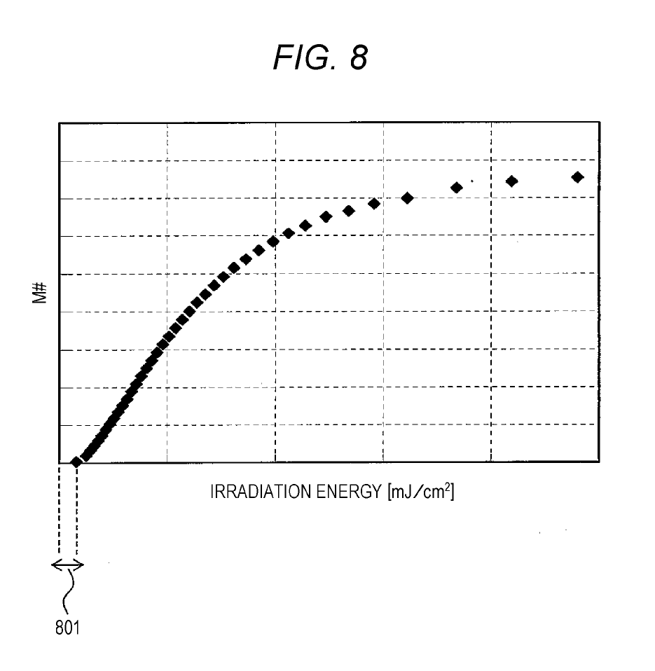

The pre-cure processing will be first supplementally described. As described above, the pre-cure is a pre-step of previously irradiating a predetermined optical beam prior to irradiating a reference light and a signal light on desired positions when recording information at a desired position in the optical information recording medium. FIG. 8 illustrates an exemplary property of the optical information recording medium made of a photopolymer material as an exemplary optical information recording medium for recording information therein by use of the holography principle. The horizontal axis indicates energy to be irradiated on the optical information recording medium, and the vertical axis indicates an index expressing a medium property called M/# (M number). M/# is an index necessary to generate a hologram in the optical information recording medium, and the amount of holograms or a density thereof recordable in the optical information recording medium can be increased at a higher M/#. When energy with a desired wavelength is irradiated on the optical information recording medium, an interference pattern is generated by an overlap between a reference light and a signal light, and the interference pattern consumes M/# in the optical information recording medium thereby to be recorded as a hologram in the optical information recording medium. Energy in a reaction active state needs to be previously irradiated on the optical information recording medium in order to enable the optical information recording medium to consume M/# and to record a hologram. Energy 801 in FIG. 8 is in the reaction active state. Therefore, before information is recorded in the optical information recording medium, energy needs to be previously implanted into the optical information recording medium by irradiating a predetermined optical beam prior to irradiating a reference light and a signal light for information recording, and a desired area needs to be in a reaction active state. The pre-recording processing is called pre-cure. It is ideal that as much energy for pre-cure as the energy 801 is accurately implanted, but energy to be irradiated is difficult to strictly adjust due to various causes such as a variation in irradiated energy due to an optical system in the device or an increase/decrease in energy 801 due to a temperature dependency of medium sensitivity, but the energy 801 or more may be irradiated on pre-cure in order to accurately record information after pre-cure.

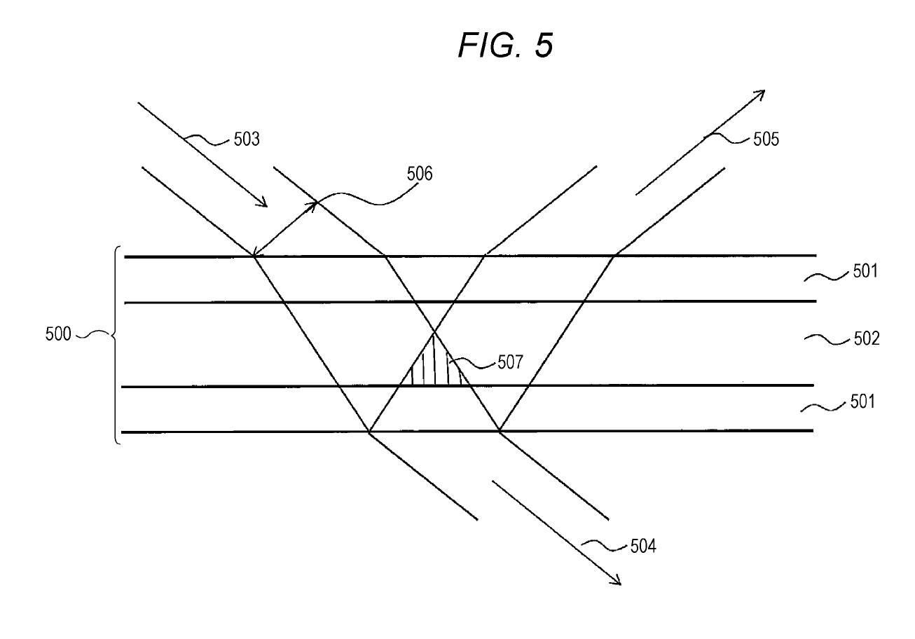

A phenomenon caused when the pre-cure processing is performed by use of a high-interference beam will be described below with reference to FIG. 5. FIG. 5 illustrates how a high-interference beam is irradiated on the optical information recording medium recording data therein based on the holography principle. 501 and 502 indicate the components configuring an optical information recording medium 500, in which 502 indicates a layer into which a recording material is implanted and 501 indicates cover layers sandwiching the layer 502 into which the recording material is implanted, which indicate a cross-section view of the optical information recording medium. 503 indicates a high-interference beam irradiated on the optical information recording medium. It is assumed herein, by way of example, that the refractive indexes of 501 and 502 are the same and the refractive indexes of 501 and 502 are different from a refractive index in the air.

When the high-interference beam 503 is incident into the optical information recording medium 500, refraction of the light is caused on the incidence due to the difference in the refractive indexes between in the air and in the optical information recording medium 500, and the incident light travels straight in the optical information recording medium 500 while changing its angle. Thereafter, the beam 503 is branched into a light 504 transmitting through the optical information recording medium 500 and a light 505 reflecting on the backside of the cover layer 501. Herein, the beam 503 has a beam width 506, and thus part of the light reflecting on the backside of the cover layer 501 partially overlaps with the incident light. At this time, the incident beam 503 has a high-interference beam, and thus interferes in the area where the incident light overlaps with the reflected light, thereby generating an interference pattern. At this time, when the irradiated energy exceeds the energy 801 in FIG. 8, the interference pattern is recorded as a hologram 507 in the layer 502 into which the recording material is implanted.

It is apparent from the experiments by the inventors that the phenomenon absolutely occurs in principle though depending on the components such as anti-reflective coating of the optical information recording medium 500 and a hologram generated at this time has an effect on recording/reproducing.

As described above, when a reference light as a high-interference beam is irradiated on the optical information recording medium 500 for pre-cure, the incident reference light interferes with the reference light reflecting on the backside of the optical information recording medium 500 thereby to generate an unwanted hologram in addition to the pre-cure effect due to implanted energy. The area is used for recording information as a hologram after pre-cure, and is where a reference light and a signal light are irradiated and interfere with each other in the same area thereby to generate a hologram during data recording.

At this time, if a reference light irradiation angle on pre-cure is the same as a reference light irradiation angle on information recording, when a reference light angle on reproduction is adjusted to be suitable for a recorded hologram while the hologram recording information therein is reproduced, the reference light angle is suitable for reproducing an unwanted hologram, and thus the hologram recording information therein is reproduced and the unwanted hologram generated on pre-cure is also reproduced at the same time. At this time, a reproduced image receive by a sensor such as camera is such that the components of a reproduced image of the hologram recording information therein and a reproduced image of the unwanted hologram generated on pre-cure overlap with each other, and a reproduced image of the information to be originally acquired is added with a noise component, which deteriorates reproduction quality. Specifically, an error rate of the reproduced images is higher and the recorded information is difficult to recover. Therefore, the above problem has to be solved in order to use a high-interference beam as a beam on pre-cure.

A method for avoiding or alleviating impacts of an unwanted hologram generated by an incident light and a reflected light of a high-interference beam according to the present invention will be described below.

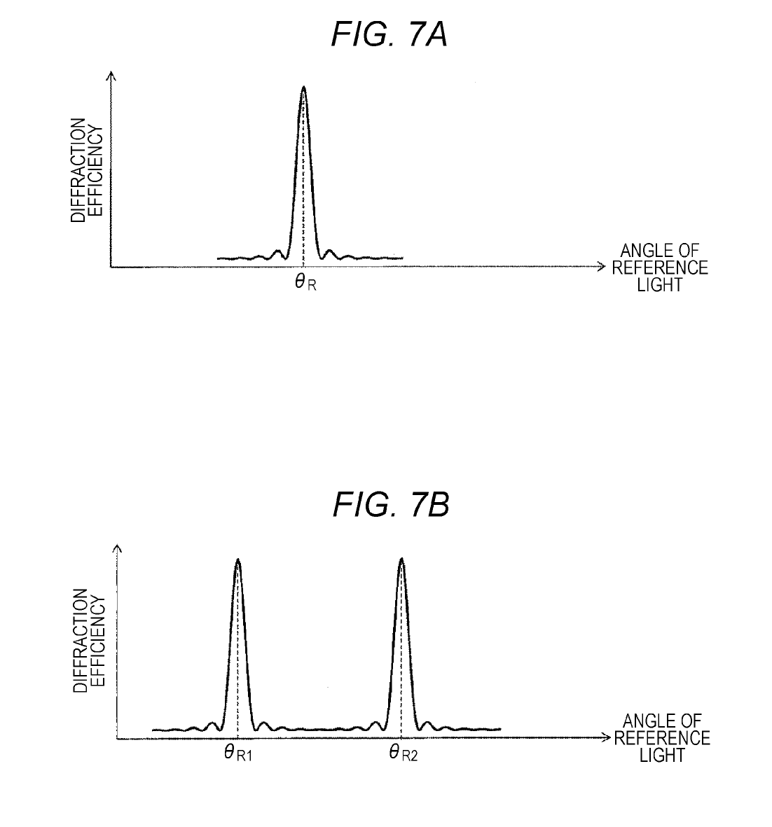

It is confirmed by the experiments by the inventors that the unwanted hologram generated by an incident light and a reflected light of a high-interference beam has angle selectivity on reproduction. The angle selectivity is a property in which reproduction is possible only in a certain range of angles on reproducing the generated holograms, and realizes the angle multiplexing recording by use of the property. According to the property, when a reference light is irradiated at an angle offset by a certain angle from the angle of the reference light at which the hologram is recorded, the desired hologram cannot be reproduced. Conversely, if a hologram is recorded at an irradiation angle offset by a certain angle from the reference light irradiation angle at which the hologram is first recorded even in the same area, a new hologram can be recorded at a different angle from the first-recorded hologram, and if the first-recorded hologram and a later-recorded hologram are reproduced, desired data can be separately reproduced if the reference light is adjusted to each recording angle. In this way, with the angle selectivity property, information is recorded at certainly separated angles so that information with excellent quality can be reproduced without crosstalk of the information recorded at different angles on reproduction. FIGS. 7A and 7B illustrate the example.

FIG. 7A illustrates an example of angle selectivity, in which the vertical axis indicates a diffraction efficiency of a hologram and the horizontal axis indicates a reference light angle. FIG. 7A indicates how a reproduced image of a hologram is viewed when an angle of the reference light is changed on reproducing the hologram recorded at θ_{R}, and indirectly indicates that the reproduced image can be reproduced with better quality as the diffraction efficiency is higher. It further indicates that a hologram recorded at θ_{R} cannot be reproduced even if the reference light is irradiated at an angle offset by a certain angle from around θ_{R}.

As illustrated in FIG. 7B, if an angle recorded at the reference light angle θ_{R1} and an angle recorded at the reference light angle θ_{R2} are separated from each other by a certain angle, reproduction is possible without any impact of the mutual holograms on reproduction.

The unwanted hologram generated by an incident light and a reflected light of a high-interference beam also has angle selectivity, and it is confirmed that the generated hologram is not reproduced by offsetting its angle by a certain angle from the angle of the incident light on reproduction.

A method for performing pre-cure at a high-interference beam and recording information by use of the property will be described below.

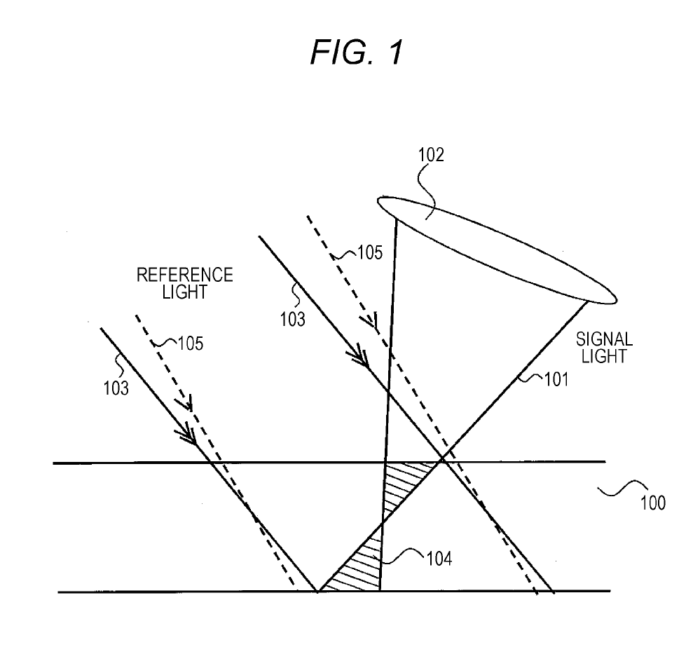

FIG. 1 illustrates how information is recorded in the optical information recording medium 100. There is illustrated an example in which a signal light for which information to be recorded is modulated is incident as a convergent light from an objective lens 102 into the optical information recording medium 100 and a reference light is incident as a parallel light into the optical information recording medium 100. Though not illustrated, there is configured such that a site corresponding to the mirror illustrated in FIG. 3 for the reference light is present in front of the incident light and a beam can be irradiated at a changed angle onto the optical information recording medium 100.

There is assumed an example in which the reference light 103 in a solid line and the convergent signal light 101 interfere with each other in the optical information recording medium 100 thereby to record information as a hologram 104.

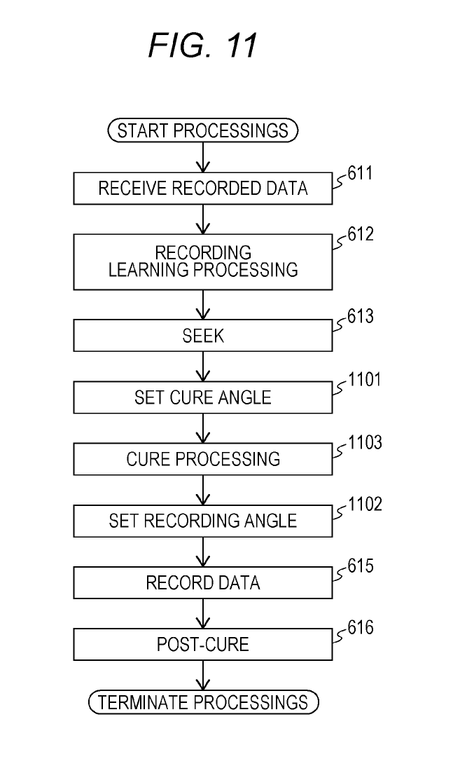

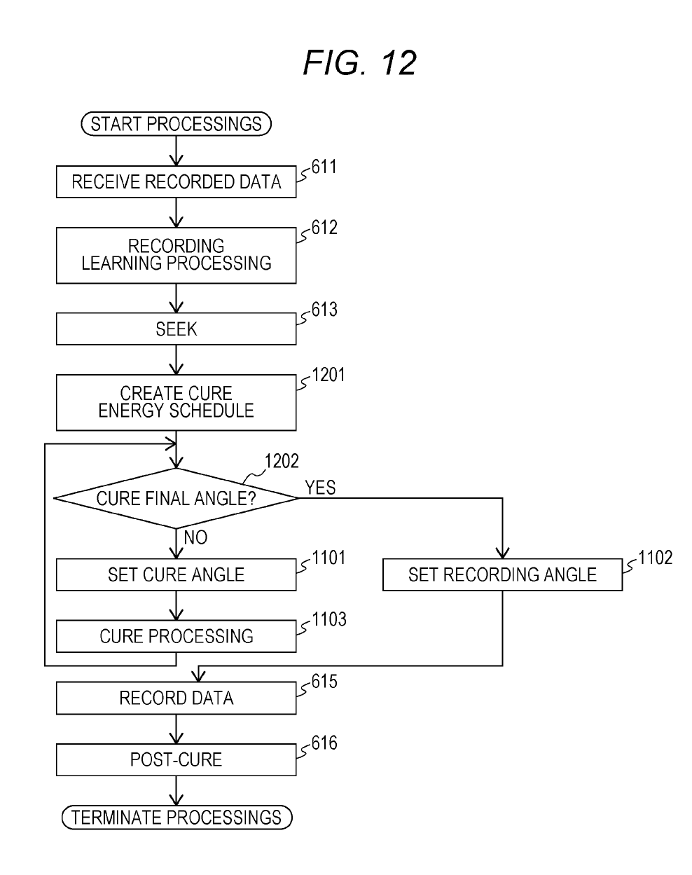

The pre-cure processing is previously required prior to recording the hologram 104, and the pre-cure is performed by use of the reference light 103 as a high-interference beam in the present example. An angle of the mirror in front of the reference light is first set at a different angle from an incident angle of the reference light 103 irradiated on the hologram recording information therein such that an unwanted hologram due to the incident light and the reflected light of the reference light 103 does not have any effect on the holograms recording information therein on reproduction. In the present embodiment, the galvanic mirror 319 is set such that the reference light is incident into the optical information recording medium 100 at an incident angle 105 in a dotted line. The angle is assumed as a certain angle such as an angle at which the diffraction efficiency is sufficiently low based on the angle selectivity property on reproduction, or a separated angle in consideration of the angle selectivity of the holograms recording information therein and the angle selectivity of the unwanted hologram generated in the pre-cure by the reference light. After an irradiation angle is set for pre-cure, as much a reference light as energy required to pre-cure is irradiated on the optical information recording medium 100. Then, the angle of the galvanic mirror 319 is set at an angle to record information, and the reference light is irradiated at the incident angle of the reference light 103 on the optical information recording medium 100. At this time, the signal light 101 is also irradiated on the optical information recording medium 100 to interfere the reference light 103 and the signal light 101, and information is recorded as the hologram 104 into the optical information recording medium 100. Thereafter, the post-cure processing to be performed after recording is performed so that the information is fixed as the hologram 104 into the optical information recording medium 100. An example of the aforementioned recording sequence is illustrated in a flowchart of FIG. 11. A cure angle setting processing (1101) is added after the seeking in the recording sequence of FIG. 6 in the present invention. In the present processing, an irradiation angle on pre-cure is set such that a beam having a pre-cure effect is irradiated apart from the recording angle by a certain angle in data recording (615). The setting is performed as described above by controlling the actuator 320 to move the galvanic mirror 319, and changing the beam angle. Thereafter, the reference light in the irradiation angle changed state is subjected to a cure processing (1103) of irradiating as much energy as required for pre-cure, and is subjected to a recording angle setting processing (1102) of controlling the actuator 320 to change the beam angle such that the angle of the galvanic mirror 319 is at the angle on data recording prior to the data recording (615), and the data recording (615).

If the angle of the galvanic mirror 319 is set at an angle at which the hologram 104 recording information therein can be reproduced on reproducing the recorded information, and the reference light is irradiated at the angle of the reference light 103 on the hologram 104, the diffractive light from the hologram 104 can be detected as a reproduced image by the optical detector 325. At this time, even if an unwanted hologram is generated on pre-cure, the reproduction quality of the hologram 104 is not influenced in terms of the angle selectivity.

The cure angle setting processing (1101) in the pre-cure processing is advantageous at an angle apart from the incident angle of the reference light by a certain angle on recording as described above, but when the incident angle is made closer to the verticality relative to the optical information recording medium, the energy density of the reference light enhances thereby to pre-cure in a small range at a high efficiency. This is advantageous in shortening the pre-cure time. On the other hand, when the range to be pre-cured is wider, the incident angle of the reference light relative to the optical information recording medium may be closer to the horizon.

The example in which a reference light is applied as an exemplary high-interference beam for the pre-cure processing has been described above, but the present example is exemplary and the high-interference beam for the pre-cure processing does not necessarily need to be a reference light. For example, similar effects can be obtained by applying a signal light as a high-interference beam for the pre-cure processing.

To pre-cure with a signal light, by way of example, all the beams from the light source 301 are deflected by the optical device 304 to be the signal lights 306, and the optical beam diameters thereof are enlarged by the beam expander 308 and then transmit through the phase mask 309, the relay lens 310 and the PBS prism 311 to be incident into the spatial optical modulator 312. In the above example, only the signal light is irradiated onto the optical information recording medium 1 in the optical device 304, but a shutter or the like may be arranged in the optical path of the reference light and only the signal light may be irradiated onto the optical information recording medium 1.

At this time, preferably information is not added in the spatial optical modulator 312. The signal light incident into the spatial optical modulator 312 reflects on the PBS prism 311 and propagates through the relay lens 313 and the spatial filter 314. Thereafter, the signal light is incident into the optical information recording medium 1 by the objective lens 315 to pre-cure.

When the reference light irradiation angle on pre-cure is the same as the reference light irradiation angle on recording, an unwanted hologram generated on pre-cure and a hologram generated on recording are recorded, and when the recorded holograms are reproduced, the hologram recorded for irradiating the reference light at an irradiation angle at which the unwanted hologram is generated, and the unwanted hologram are reproduced at the same time, and the recorded holograms are not correctly reproduced. Thus, the above method avoids this problem by setting the reference light irradiation angle on pre-cure at a different angle from the reference light irradiation angle on recording. When the signal light is used to pre-cure, only the signal light is irradiated at a recording position like when pre-cure is performed by a reference light. At this time, an unwanted hologram is generated due to the irradiated signal light and the reflected light reflected from the backside of the disk. After pre-cure is performed by the signal light, the reference light and the signal light are irradiated and a hologram is generated and recorded due to an interference between the reference light and the signal light, but when the recorded hologram is reproduced, it is reproduced by irradiating the reference light, and thus the unwanted hologram due to the reflected signal light generated on pre-cure is a hologram generated at a different irradiation angle from the irradiation angle of the reference light on reproduction. Therefore, the unwanted hologram generated on pre-cure by the signal light does not have an effect on the reproduced hologram, which does not deteriorate reproduction quality. In this way, the signal light irradiated at a different angle from the irradiation angle of the reference light for reproduction can be applied for a pre-cure beam.

The pre-cure processing and the recording processing are performed in the above procedure so that an unwanted hologram is recorded at an angle having no effect on reproduction quality, and thus holograms recording information therein can be reproduced with excellent quality without being influenced by the unwanted hologram.

### Second Embodiment

There will be considered a case in which information is multiplex-recorded while an angle relative to the optical information recording medium is being changed multiple times in order to record information in the optical information recording medium. At this time, it is assumed that holograms generated for recording information are recorded at lower angle intervals in order to increase a recording density into the optical information recording medium. When the angle intervals for recording information are low, a remarkably small angle, at which the diffraction efficiency is sufficiently low, may occur due to the angle selectivity on reproduction depending on the angle selectivity of an adjacent hologram. In this case, if pre-cure is performed with a high-interference beam, the pre-cure angle is difficult and problematic to set at an angle sufficiently apart from the angle of the hologram recording information therein in consideration of generation of an unwanted hologram on pre-cure.

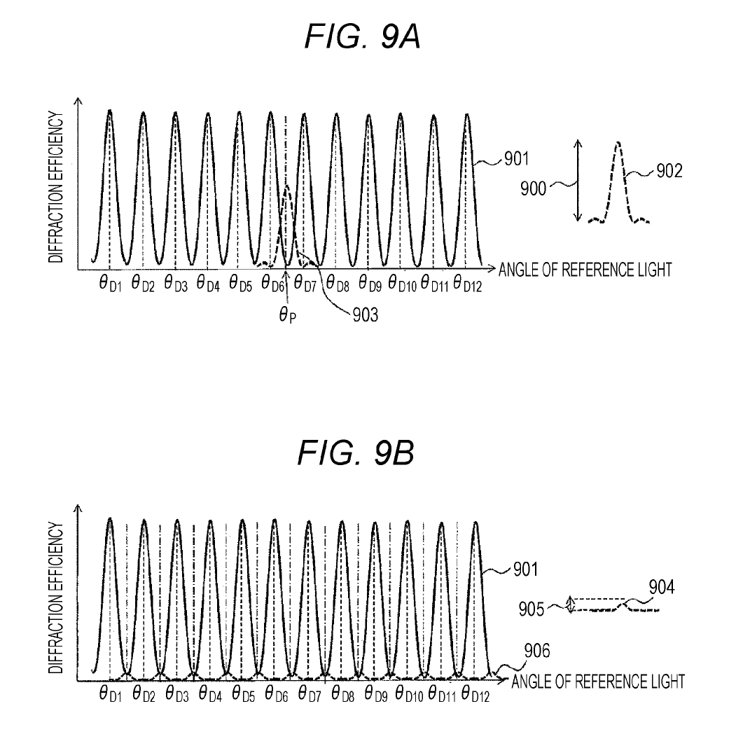

In order to solve the above problem, according to the present invention, energy required to pre-cure is divided and irradiated on the optical information recording medium while a beam irradiation angle for pre-cure is being changed multiple times. A case in which a pre-cure beam with certain energy is irradiated at a predetermined angle and a case in which a pre-cure beam is divided and irradiated at multiple angles are illustrated in FIG. 9A and FIG. 9B, respectively, for comparison. 901 indicates that holograms for recording information are generated at multiple angles θ_{D1} to θ_{D12}, and indicates an angle selectivity curve of the holograms. The diffraction efficiency is maximum at the reference light angles θ_{D1}, θ_{D2}, . . . , θ_{D12}. 902 in a dotted line indicates angle selectivity of an unwanted hologram generated when energy required for pre-cure is irradiated on the optical information recording medium by use of a high-interference beam. When a high-interference beam is used on pre-cure, the beam is irradiated at an angle offset from the reference light irradiation angle for generating a hologram recording information therein, and thus the pre-cure angle is set at the farthest angle from the angle for recording adjacent information, for example, at θ_{P}. At this time, the unwanted hologram generated on pre-cure has the angle selectivity 903, and thus when the hologram recording information therein with the property 901 is reproduced, the reproduction quality of the holograms recorded at θ_{D6} and θ_{D7} is largely influenced by noise, and is remarkably deteriorated.

On the other hand, FIG. 9B illustrates a case in which as much energy as the energy irradiated for pre-cure in FIG. 9A is irradiated while it is divided and changed in its incident angle multiple times. FIG. 9B illustrates an example in which an angle to irradiate a high-interference laser is divided into 12 angles on pre-cure. A plurality of interferences between an incident light and a reflected light occur so that holograms are generated at multiple angles, but the irradiation energy is divided to be low at each angle, and thus the angle selectivity of each of the generated holograms is like the property 904, and an unwanted hologram with a low diffraction efficiency 905 is generated for the diffraction efficiency 900 of an unwanted hologram generated at a fixed angle. FIG. 9B illustrates that a high-interference laser with divided energy is irradiated on pre-cure at an intermediate angle of all the angles θ_{D1} to θ_{D12} as the reference light angles for generating the holograms to record information therein, which causes an angle selectivity curve 906 of the generated unwanted hologram. The unwanted hologram may have an effect on the reproduction quality of the holograms recording at least the information at θ_{D1} to θ_{D12}, but the impact can be restricted to be very small due to a low diffraction efficiency at each angle, and deterioration in the reproduction quality can be ignored.

In this way, when a high-interference beam is applied on pre-cure, energy is divided and implanted at multiple incident angles apart from the incident angle of the reference light for recording information by a predetermined angle, thereby enabling to pre-cure without deterioration in the reproduction quality on the high-density multiplex recording. Further, the effect can be realized without an increase in the pre-cure angle of the device or in a drive range of the reference light angles, and thus the effects can be advantageously obtained without changing the optical system designs of the device such as an objective lens design immediately prior to irradiating a signal light on the optical information recording medium, a lens design immediately prior to irradiating a reference light on the optical information recording medium, and a physical arrangement design of a reference light beam angle changing device.

An example of the aforementioned recording sequence is illustrated in a flowchart of FIG. 12. After the pickup 11 and the cure optical system 13 are positioned at desired positions in the seek processing (613), an irradiation energy schedule is created depending on an angle at which a reference light is irradiated onto the optical information recording medium 1 (1201). The schedule is to previously determine a relationship between an irradiation angle and irradiation energy in order to irradiate a reference light at irradiation angles, and the irradiation energy may be defined by an irradiation time or irradiation power. For example, when energy is uniformly irradiated at each angle, a value obtained by dividing energy required to pre-cure by the number of irradiation angles is irradiation energy to be irradiated at an individual angle. After a cure energy schedule creation processing (1202), a cure processing (1103) is performed while a plurality of cure angles are set (1101). At this time, whether all the scheduled angles are completed is monitored, and a cure final angle determination processing (1202) is performed. The sequence is such that after it is determined that the cure ends in the cure final angle determination processing (1202), the angle is set at a recording angle for data recording (1102), and the data recording processing (615) is performed.

### Third Embodiment

When an exit laser with a variable wavelength of a high-interference beam is used, a wavelength to be irradiated on recording is different from a wavelength to be irradiated on pre-cure, thereby being less subject to an impact of an unwanted hologram generated on pre-cure.

There has been described above that a reference light is irradiated to acquire a reproduced image depending on an angle of a recorded hologram for reproducing the hologram, but at this time, a wavelength of a reference light to be irradiated is also important. When the wavelength of the reference light is not proper for the hologram to be reproduced, the diffraction efficiency of the reproduced image lowers like when the angle of the reference light is not proper. By use of the property, the wavelength of the high-interference beam to be irradiated on pre-cure is offset from the wavelength of the reference light on recording information so that an optimum wavelength for reproducing the recorded information is different from an optimum wavelength for reproducing the unwanted hologram generated on pre-cure, and when the recorded information is reproduced, an impact of the hologram generated on pre-cure is lower.

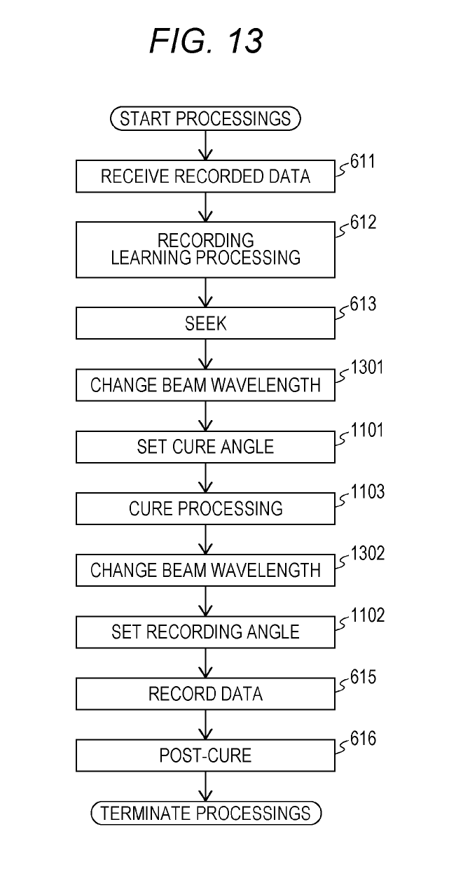

An example of the aforementioned recording sequence is illustrated in a flowchart of FIG. 13. After the pickup 11 and the cure optical system 13 are positioned at desired positions in the seek processing (613), a reference light beam wavelength changing processing (1301) is performed. A wavelength to be changed at this time is assumed to be different from a wavelength of a reference light to be set in the data recording processing (615). The reference light wavelength changing processing is performed in the beam wavelength control unit 93 provided in the light source 301. Thereafter, the reference light is set at an angle on cure irradiation (1101), and is subjected to the cure processing (1103). The sequence is such that after the cure processing (1103), the wavelength of the reference light is changed to the wavelength on data recording (1302), the irradiation angle is set at a recording angle for data recording (1102), and then the data recording processing (615) is performed.

The beam wavelength changing processing (1301) for pre-cure and the beam wavelength changing processing (1302) for data recording are indicated in the sequence as the pre-processings of the cure angle setting processing (1101) and the recording angle setting processing (1102), respectively, but both may be performed before the cure processing (1103) and the data recording (615), respectively, the order of the beam wavelength changing processing (1301) and the cure angle setting processing (1101) may be rearranged, and the order of the beam wavelength changing processing (1302) and the recording angle setting processing (1102) may be rearranged.

### Fourth Embodiment

Further, a high-interference beam is lowered in its interference, thereby lowering a diffraction efficiency of a generated unwanted hologram. By way of example, if mode hopping occurs to a laser as a beam origination source, even a high-interference beam on normal time changes from the single mode to the multi-mode and the beam enters unstable. At this time, the interference remarkably lowers. The interference of a beam is important for generating a hologram, and a hologram with a high diffraction efficiency is difficult to generate at lower interference.

By use of the property, according to the present invention, when a high-interference beam is used on pre-cure, the interference is temporarily lowered on irradiation for pre-cure.

By way of example, there will be described a case in which a reference light used on recording is used as a beam to be irradiated on pre-cure.

In the first method, a high frequency is superimposed on a reference light thereby to lower its interference. The present method is such that a laser as a beam origination source has the function of superimposing a high frequency, the laser/high frequency superimposition function is enabled prior to performing pre-cure, and a laser is output in the high frequency superimposed state. Thereby, the reference light is in the high frequency superimposed state and its interference remarkably lowers. Pre-cure is performed on the reference light in this state. When information is recorded in a pre-cured area after the pre-cure, the laser/high frequency superimposition function is disabled, the laser interference is recovered to the original high state to irradiate the reference light and the signal light, and the information is recorded as a hologram. As described above, since a low-interference beam superimposed with a high frequency is irradiated on pre-cure, even if an incident light overlaps with a reflected light on pre-cure, a hologram with a high diffraction efficiency is not generated. Thus, when the recorded information is reproduced, an unwanted hologram generated on the pre-cure is less influential.

In another method, mode hopping is caused by intentionally varying a laser power or wavelength prior to pre-cure, thereby lowering a beam interference. In this case, the conditions such as power and wavelength under which mode hopping occurs in a laser using environment are previously investigated and the conditions are set for a laser prior to pre-cure. After pre-cure, the laser setting values of power and wavelength may be reset at the normal setting in order to return the laser to the single mode. Also in the present method, a beam interference for pre-cure lowers, and thus a diffraction efficiency of an unwanted hologram generated on the pre-cure lowers, and when the recorded information is reproduced, the unwanted hologram generated on the pre-cure is less influential.

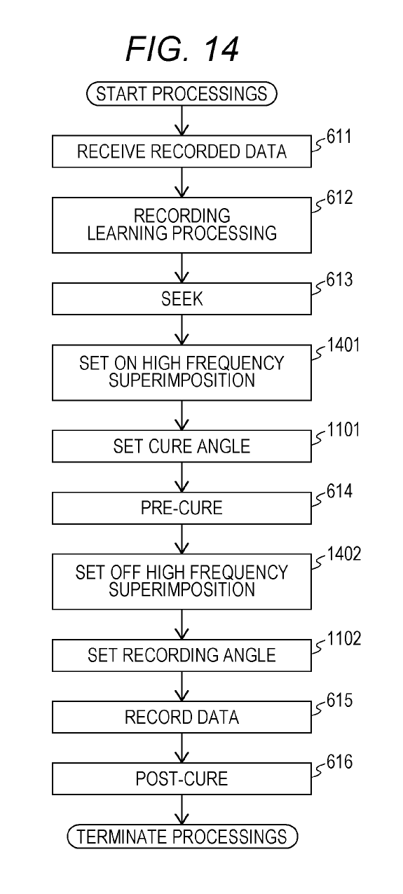

An example of the aforementioned recording sequence is illustrated in a flowchart of FIG. 14. After the pickup 11 and the cure optical system 13 are positioned at desired positions in the seek processing (613), the high frequency superimposition unit 94 provided in the light source 301 is enabled (1401) to superimpose a high frequency on the reference light. Thereafter, the reference light is set at an angle on cure irradiation (1101) to perform the cure processing (1103). After the cure processing (1103), the high frequency superimposition unit 94 provided in the light source 301 is disabled (1401) to release the beam/high frequency superimposed state. Thereafter, the sequence is such that the angle is set at a recording angle for data recording (1102) and then the data recording processing (615) is performed.

The processing (1401) of enabling the laser/high frequency superimposition function and the processing (1402) of disabling the laser/high frequency superimposition function for data recording are indicated in the sequence as the pre-processings of the cure angle setting processing (1101) and the recording angle setting processing (1102), respectively, by way of example, but may be performed before the cure processing (1103) and the data recording (615), respectively, the order of the processing (1401) of enabling the laser/high frequency superimposition function and the cure angle setting processing (1101) may be rearranged, and the order of the processing (1402) of disabling the laser/high frequency superimposition function and the recording angle setting processing (1102) may be rearranged.

### Fifth Embodiment

There has been described above the method for performing pre-cure so as not to lower reproduction quality of recorded information by use of a high-interference beam.

There will be described herein a method for synchronizing the pre-cure processing and the recording processing thereby to simplify the recording sequence as an application of the present invention.

There will be described a case in which a reference light used on recording and reproducing is used as a pre-cure beam.

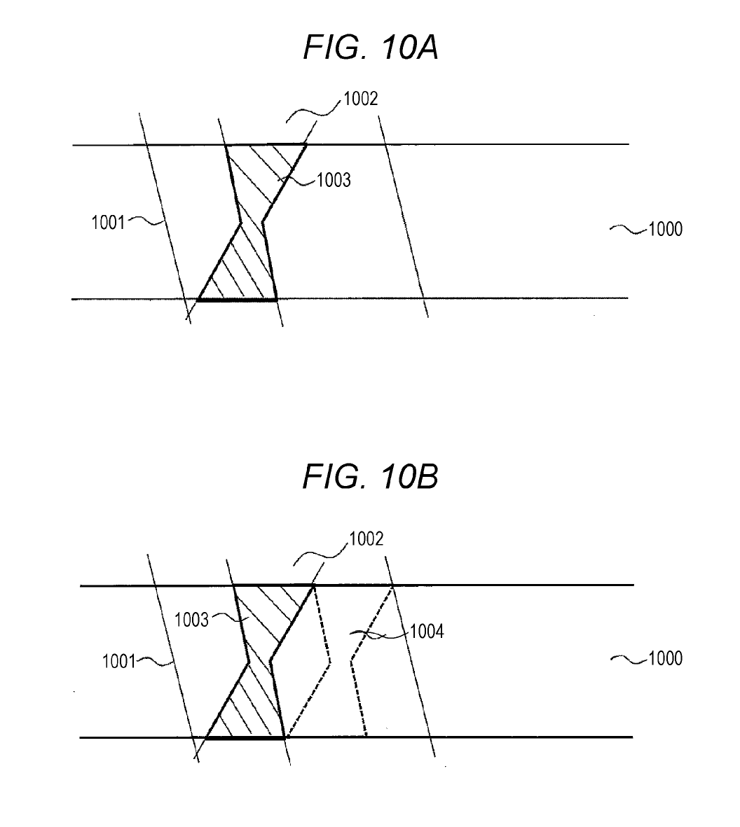

As described above in FIG. 6B, the hologram recording sequence is such that the pre-cure processing is performed prior to recording information, and then the information is recorded. In the present invention, a reference light can be applied on pre-cure, and when holograms are consecutively recorded by use of the fact, the pre-cure effects can be obtained while the holograms are being recorded. The recording will be described with reference to FIGS. 10A and 10B.

FIG. 10A illustrates how a reference light 1001 and a signal light 1002 are irradiated on an optical information recording medium 1000 to record a hologram by way of example. The present embodiment assumes that a plurality of holograms are recorded in other area. That is, the example is that a plurality of books are recorded in the optical information recording medium in the terms used in FIG. 2. In the present embodiment, a reference light is denoted as 1001, and a light converging toward the optical information recording medium 1000 is denoted as 1002. A part where the reference light 1001 crosses with the signal light 1002 is a hologram 1003 to be recorded. In the present embodiment, an area where a book is recorded is assumed to be moved in the right direction in the drawing and to be recorded. In the present embodiment, for easy understanding of the description, a light flux of the reference light 1001 is spread toward an area where a book is recorded next. In the present embodiment, the number of holograms to be recorded in a book (the number of pages in the terms described in FIG. 2) is assumed as 1.

At first, it is assumed that the conditions under which pre-cure is performed are met in an area where the hologram 1003 to be first recorded is generated. To pre-cure for recording a first hologram may be to pre-cure by the reference light 1001, or to pre-cure using another cure light source. When the reference light 1001 and the signal light 1002 are irradiated as illustrated in FIG. 10A under the conditions under which pre-cure is performed, the first hologram 1003 is generated in the optical information recording medium. At this time, the reference light 1001 is irradiated up to the area on the right side in the drawing to the hologram 1003, and energy is implanted into the optical information recording medium 1000 for the area irradiated by the reference light 1001. If the energy implanted in the area is enough to pre-cure (the amount of energy for making the optical information recording medium in the reaction active state), the fact equivalently indicates that pre-cure is previously performed, and a hologram for recording information therein is ready to be generated without performing the pre-cure processing in the area. For example, when next information is recorded at a hologram 1004 as illustrated in FIG. 10B, according to FIG. 6B, conventionally pre-cure is performed after the seek processing 613 for changing a relative position where the reference light 1001 and the signal light 1002 are irradiated on the optical information recording medium 1000 is performed, and then the recording processing is performed, but according to the present invention, the reference light 1001 and the signal light 1002 are irradiated to record the hologram 1004 without performing the pre-cure processing 614 after the seek processing 613. Similarly, also when a next hologram is recorded, the similar effects to the pre-cure processing are obtained in a next hologram recording area by the energy of the reference light irradiated for generating the hologram 1004, and thus information can be consecutively recorded as holograms without the pre-cure processing 614.

At this time, as described above, the reference light irradiation angle for recording information as a hologram needs to be different from the reference light irradiation angle on pre-cure in order to perform the present processing, and thus in the present invention, the reference light irradiation angle on recording the hologram 1003 is different from the reference light irradiation angle on recording the hologram 1004 for recording. That is, when information is recorded in the optical information recording medium 1000, the reference light angle of the hologram to be recorded is set at a different angle from a hologram to be recorded in an adjacent area. Thereby, the reference light 1001 irradiated for recording the hologram 1003 gives the same effects as the pre-cure processing to the area where next information is recorded as a hologram, and further an unwanted hologram generated by pre-cure with the reference light is generated at a different angle from the recording angle of the hologram 1004 recording next information therein, and thus the unwanted hologram does not influence the reproduction quality of the hologram 1004 when the hologram 1004 is reproduced, which can avoid deterioration in the reproduction quality of the hologram 1004.

Furthermore, the present embodiment has described the case in which one page is recorded in one book for the convenient description, but when angle multiplex-recording is performed, or also when a plurality of pages are recorded in one book, if the recording angle of an adjacent hologram is set at a different angle in each page, the same effects can be obtained as in one page.

The present embodiment has described the example in which a light flux of the reference light 1001 is larger, but if an area where a next hologram is recorded can be pre-cured, the light flux of the reference light can be flexibly set.

When the energy for the reference light on recording a hologram does not solely reach the energy required to pre-cure, the energy for the reference light per page on recording may be increased. Accordingly, the energy for the signal light is adjusted thereby to adjust a diffraction efficiency of a generated hologram.

Another solution for the case in which the energy for the reference light on recording a hologram does not solely reach the energy required to pre-cure may be a method for recording a page recording information therein on recording a hologram, then setting a reference light angle at a different angle from the page recording information therein and from an angle at which next information is recorded as a hologram, blocking a light of a signal light all that time, and irradiating as much a reference light as the lacking energy required to pre-cure in the area where a next hologram is recorded.

With the present invention applied, another hologram to be recorded in an area where the pre-cure effects can be obtained by a reference light beam on the recording processing is set at a different angle from the angle of the reference light beam on recording a hologram, and is recorded so that recording and reproducing can be performed without deterioration in the reproduction quality of the hologram recording information therein, and the recording operation can be consecutively performed without intentionally performing the pre-cure processing from the recording sequence.

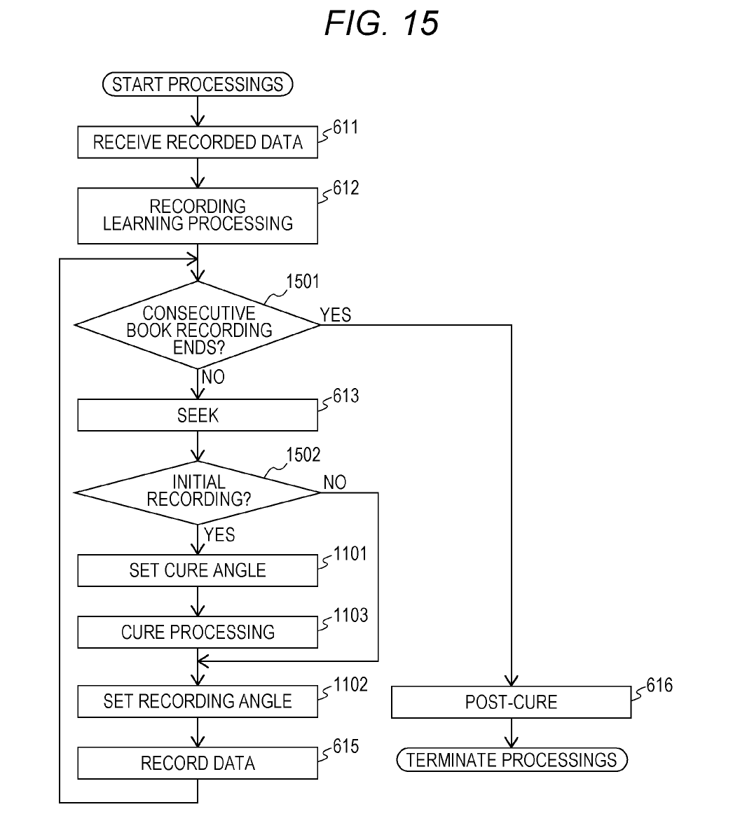

An example of the aforementioned recording sequence is illustrated in a flowchart of FIG. 15. The present embodiment indicates an example in which a plurality of books are adjacently and consecutively recorded, and the sequence is such that data is first recorded at a desired position and then the recording processing is performed again at a different position. The following sequence is repeated until the consecutive recording ends in a consecutive book recording end confirmation processing (1501) after the recording learning processing (612) is performed to prepare a recordable state. At first, after the pickup 11 and the cure optical system 13 are positioned at desired positions in the seek processing (613), a determination is made as to whether the recording at a desired position is the initial recording requiring pre-cure (614). As a result of the determination (1502), if the recording is the initial recording, a beam is set at an angle on cure irradiation (1101) to perform pre-cure (614). The sequence is such that after the pre-cure (614), the angle is set at a recording angle for data recording (1102) and then the data recording processing (615) is performed. Thereafter, whether the consecutive recording ends is confirmed again in the consecutive book recording end confirmation processing (1501). When the consecutive recording is ongoing, the seek processing (613) for changing the recording position is performed. In the present example, the pre-cure effects at a next recording position are obtained by the reference light beam on the initial recording, and thus the processing proceeds to the recording angle setting processing (1102) in and subsequent to the second recording without performing the processings for the pre-cure, thereby performing the data recording (615). Subsequently the recording operation continues without performing the processings for the pre-cure until the consecutive book recording for adjacently recording books interrupts. When the consecutive book recording ends, the recording sequence is such that the processing proceeds from the consecutive book recording end confirmation processing (1501) to the post-cure (616).

### Sixth Embodiment

There has been described the method for realizing the pre-cure processing or the similar effects to the pre-cure by irradiating a high-interference beam, and reproducing holograms recording information therein without deterioration in reproduction quality, but the present application is also applicable to the post-cure processing.

To post-cure is a post-step of recording information as a hologram at a desired position in the optical information recording medium, and then irradiating an optical beam until M/# in a predetermined area is consumed in order to disable the desired position to be additionally recorded.

Also on post-cure, when a high-interference beam is used, the state is close to the principle of reproducing a hologram depending on an angle to irradiate a beam on a hologram in a desired area, and an angle at which a diffractive light is irradiated from the recorded hologram is present. In this case, the diffractive light interferes with an incident light again, and an unwanted hologram is generated as a noise source. In order to avoid the problem and to perform post-cure with a high-interference beam, a beam may be irradiated at an angle apart from the angle at which a hologram recording information therein is reproduced as described above. Thereby, the contents described by way of the pre-cure processing can be similarly applied in post-cure.

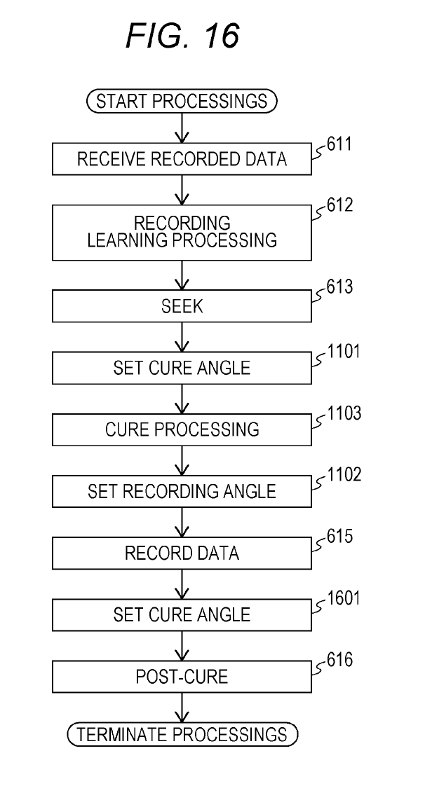

An example of the aforementioned recording sequence is illustrated in a flowchart of FIG. 16. After the seek processing (613), an irradiation angle on pre-cure is set such that a beam giving the pre-cure effects is irradiated at a position apart from the recording angle by a certain angle in the cure angle setting (1101) and the data recording (615). Thereafter, pre-cure (614) is performed in the irradiation angle changed state, and the angle is set at a recording angle for data recording (1102) after the pre-cure (614), and then the data recording processing (615) is performed. Thereafter, prior to performing the post-cure (616), the angle in the data recording (615) is set at an angle to irradiate a reference light on post-cure (1601). Thereafter, the post-cure (616) is performed.

The present example is an exemplary recording sequence on post-cure, and can be used as an application of the embodiment on pre-cure.

There has been described above many examples in which a reference light beam is applied as a cure beam, but in the present application, the method for applying a high-interference beam as a cure beam has been described above, and the example in which a reference light is applied is merely exemplary. The present application may be applied to any high-interference beam such as signal light beam.

The present invention is not limited to the above embodiments, and encompasses a variety of variants. For example, the above embodiments have been described in detail for easy understanding, and are not necessarily limited to the structure including all the components described above. Further, part of the structure according to an embodiment may be replaced with the structure according to other embodiment, and the structure according to an embodiment may be added with the structure according to other embodiment.

What is claimed is:

1. An optical information recording device for recording digital information in an optical information recording medium by use of holography, the device comprising:
a light source for outputting an optical beam for recording information in the optical information recording medium; and
a recording processing control unit for inputting the optical beam output from the light source at an incident angle different from an incident angle of an optical beam on the optical information recording medium when the digital information is reproduced from the optical information recording medium, thereby to perform a pre-processing or post-processing.

2. An optical information recording device for recording digital information in an optical information recording medium by use of holography, the device comprising:
a light source for outputting a reference light for recording information in the optical information recording medium; and
a recording processing control unit for inputting the reference light output from the light source at an incident angle different from an incident angle of a reference light on the optical information recording medium when the digital information is recorded in the optical information recording medium, thereby to perform a pre-processing or post-processing.

3. The optical information recording device according to claim 2,
wherein the recording processing control unit controls the reference light to be input at a plurality of incident angles.

4. The optical information recording device according to claim 2,
wherein the recording processing control unit mutually changes a wavelength of a reference light when the digital information is recorded in the optical information recording medium and a wavelength of a reference light when the pre-processing or post-processing is performed.

5. The optical information recording device according to claim 2,
wherein the recording processing control unit mutually changes an interference of a reference light when the digital information is recorded in the optical information recording medium and an interference of a reference light when the pre-processing or post-processing is performed.

6. An optical information recording method for an optical information recording device for recording digital information in an optical information recording medium by use of holography, the method comprising:
outputting an optical beam for recording information in the optical information recording medium; and
inputting the optical beam output from the light source at an incident angle different from an incident angle of an optical beam on the optical information recording medium when the digital information is reproduced from the optical information recording medium, thereby to perform a pre-processing or post-processing.

7. An optical information recording method for an optical information recording device for recording digital information in an optical information recording medium by use of holography, the method comprising:
outputting a reference light for recording information in the optical information recording medium; and
inputting the output reference light at an incident angle different from an incident angle of a reference light on the optical information recording medium when the digital information is recorded in the optical information recording medium, thereby to perform a pre-processing or post-processing.

8. The optical information recording method according to claim 7,
wherein inputting the output reference light at an incident angle different from an incident angle of a reference light on the optical information recording medium when the digital information is recorded in the optical information recording medium, thereby to perform a pre-processing or post-processing comprises:
inputting a reference light at a plurality of incident angles.

9. The optical information recording method according to claim 7,
wherein inputting the output reference light at an incident angle different from an incident angle of a reference light on the optical information recording medium when the digital information is recorded in the optical information recording medium, thereby to perform a pre-processing or post-processing comprises:
mutually changing a wavelength of a reference light when the digital information is recorded in the optical information recording medium and a wavelength of a reference light when the pre-processing or post-processing is performed.

10. The optical information recording method according to claim 7,
wherein inputting the output reference light at an incident angle different from an incident angle of a reference light on the optical information recording medium when the digital information is recorded in the optical information recording medium, thereby to perform a pre-processing or post-processing comprises:
mutually changing an interference of a reference light when the digital information is recorded in the optical information recording medium and an interference of a reference light when the pre-processing or post-processing is performed.
